(19) United States
(12) Patent Application Publication
(10) Pub. No.: US 2012/0105272 A1
(43) Pub. Date: May 3, 2012

(54) METHOD FOR FILTERING THE RADAR ECHOES PRODUCED BY WIND TURBINES

(75) Inventors: Michel Moruzzis, La Norville (FR); Gilles Beauquet, Boulogne (FR); Frédéric Campoy, Bagneux (FR)

(73) Assignee: THALES, NEUILLY SUR SEINE (FR)

(21) Appl. No.: 13/140,801

(22) PCT Filed: Dec. 11, 2009
(86) PCT No.: PCT/EP2009/066985

§ 371 Date: Oct. 19, 2011

(30) Foreign Application Priority Data
Dec. 19, 2008 (FR) 0807211

(51) Int. Cl. G01S 7/292

(52) U.S. Cl. 342/159

(57) ABSTRACT

In the field of the radar monitoring of airspace zones, and more particularly to the low altitude air surveillance of zones that are more or less densely populated with fixed objects comprising moving parts, such as wind turbines for example, two processing modules are applied to the raw signal S_{b}(t) received by the radar. The first module carries out the recognition in the signal S_{b}(t) of a signal reflected by a wind turbine, the recognition being performed by detecting an evolution in the course of time of the amplitude of the signal received S_{b}(t), characteristic of this type of signal. The first module also formulates a spurious-signal model either directly on the basis of the signal S_{b}(t) or on the basis of external real-time information relating to the operating state of the wind turbine whose signal has been detected. The second module executes the filtering proper of the signal S_{b}(t), this filtering consisting in subtracting the spurious-signal model s(t) from the signal S_{b}(t). The filtered signal S_{f}(t) is transmitted to the processing operating downstream of the method according to the invention.

The invention concerns the field of the radar monitoring of airspace zones. It relates more particularly to the low altitude air surveillance of zones that are more or less densely populated with fixed objects comprising moving parts, wind turbines for example.

In the field of radar detection it is known to implement processing methods making it possible to get rid of echoes emanating from stationary objects, also called fixed echoes. Diverse known processing methods, not described here, makes it possible to identify objects that are completely fixed and to process the echoes reflected by these objects in a separate manner, these processing possibly consisting of a simple elimination or else of a use to determine the geographical positioning and the extent of such objects. The identification of the fixed echoes advantageously makes it possible to prevent the corresponding blips from being transmitted to the radar tracking function, and to prevent overloading of this function by inducing the initialization of tracks which, no sooner initialized, are eliminated.

In a very general and known manner, the identification of fixed echoes is done by simple Doppler filtering carried out in the spectral domain, the echo reflected by a completely fixed object, a building or a relief element for example, being endowed with a zero Doppler frequency or, in the case of vegetation elements such as trees for example, a very low Doppler frequency corresponding to the motion of the foliage. Accordingly the elimination of such echoes is carried out by simple filtering, rejecting the echoes whose Doppler frequency is low, or indeed zero.

As regards elimination of the echoes reflected by fixed objects, a strongly disturbing particular situation is created by the presence of wind turbines in the space monitored by the radar. Indeed, wind turbines, although being stationary objects whose position is in principle invariant, do however exhibit moving parts, generally undergoing rotary motions. These moving parts consist mainly of the blades which rotate under the action of the wind, and whose speed of rotation depends on the speed of the wind. These moving parts also consist of the rotor as a whole, which rotor orients itself automatically in the direction of the wind.

As a consequence of the motion of the moving elements of a wind turbine, the echo reflected by a wind turbine may be endowed with a Doppler frequency whose value is comparable with that of moving echoes corresponding to objects in motion whose progress needs in particular to be taken into account by the tracking function. Thus for example, the typical speed of travel of the end of a wind turbine blade is of the order of 250 km/h, a speed which corresponds to that of certain private airplanes. Accordingly, simple elimination of these echoes by Doppler filtering is not conceivable for fear of also eliminating the echoes of objects actually in motion.

The identification and elimination of echoes originating from wind turbines is a problem which-takes on a particularly current relevance. Indeed, the effect of the proliferation of wind turbines in current landscapes is that in certain zones subjected to radar monitoring, either civil or military monitoring, the installation of a consequent number of wind turbines causes an impairment which hinders the effectiveness of the radar system. Indeed, in the absence of particular processing, the echoes reflected by wind turbines are regarded as moving echoes. Accordingly these echoes periodically cause the initialization of tracks, the effect of this being to induce a needless increase in the computational load of the tracking function, this increase being all the more significant the larger the number of wind turbines located in the space covered by the radar considered.

According to the current state of the art, known procedures exist for solving the problem posed by the echoes originating from wind turbines. These procedures, not described here, are generally based on the acquisition by the radar of the position of the wind turbines present in the space considered. The solution used generally consists in invalidating the detection of any radar echo in a zone which includes the wind turbines. It consists alternatively in maintaining active the detection of the echoes in the zones considered but in activating the NAI (“Non Automatic Initiation”) function responsible for disallowing at the level of the radar tracking, in the zones considered, the automatic initialization of tracks on the basis of the blips formed. The initialization of tracks in these zones must then be managed by an operator.

These procedures present the advantage of not requiring any particular processing of the echoes received. The echoes originating from the prohibited zones are, in principle, eliminated or do not give rise to any track initialization whatsoever.

On the other hand, they present the drawback of disallowing fast detection of targets appearing in a zone for which the prohibiting of the blips (or tracks) is activated. This limitation is for example penalizing for the detection of hostile aircraft which unmask themselves above a hill on which a wind turbine farm is installed.

These procedures also present the drawback of potentially causing losses of established tracks, particularly in the case where a tracked aircraft enters such a zone or else maneuvers in such a zone.

They present the drawback, finally, of being applicable only in the case where the space covered by the radar encloses only a small number of wind turbines located in a few precise zones. They become practically unusable in the case where wind turbines are present in large numbers and located in diverse zones.

Consequently the implementation of such procedures may be considered to be acceptable only if the size of the zones occupied by the wind turbines is sufficiently modest. Now, generalization of the exploitation of wind energy is leading to a considerable extension in the zones in which wind turbines are installed, thereby greatly impeding the operational mission of certain radars, in particular air traffic control radars, civil or military, sited in places where they are surrounded by wind turbines.

Faced with the proliferation of wind turbines, work has been undertaken to attempt to globally improve the operation of radars in such an environment. Thus, the patent application for the United States of America, filed by the company Raytheon, published on 15 May 2008 under the reference US200801111731 and entitled “Dual beam radar system” tackles the subject of procedures for filtering wind turbine echoes. However the problem is tackled here in terms of altitude, by considering that the wind turbines have a height which is less than a fixed limit, so that the echo originating from a small aircraft flying at low altitude may be regarded as a wind turbine echo and thus eliminated.

Consequently no really satisfactory solution to the problem posed by the presence of wind turbines exists to date.

An aim of the invention is to propose a solution making it possible to prevent the echoes reflected by wind turbines from overloading the radar tracking function, by escalating notably the initializations of tracks. Another aim of the invention is to allow a radar placed in an environment populated with wind turbines to ensure continuity of the tracking of moving objects even when the latter are led to pass through zones in space in which wind turbines are situated.

For this purpose the subject of the invention is a method for filtering the radar echoes produced by wind turbines, said wind turbines being positioned in the space covered by a radar comprising means for carrying out the automatic tracking of moving echoes. The method, applied to the radar signal received S_{b}(t) by analyzing this signal over a given duration, comprises mainly:
a first module for recognizing the signal reflected by a wind turbine and for constructing a spurious-signal model s(t), this model constituting an estimation, for the duration considered, of the signal reflected by a wind turbine;
a second module for filtering the radar signal received S_{b}(t), the filtering consisting in subtracting the signal s(t) from the signal S_{b}(t). The filtered signal S_{f}(t) is transmitted to the signal processing functions situated downstream of the method.

According to the invention, the recognition of the signal reflected by a wind turbine is carried out by analyzing the variation in the course of time, for the duration of observation, of the amplitude of the raw signal S_{b}(t) received.

In a particular mode of implementation of the invention, the recognition of a signal reflected by a wind turbine is carried out by searching for amplitude peaks and by determining the duration of these peaks and the amplitude deviation existing between these peaks and the mean value of the signal S_{b}(t) over the duration of observation, this deviation being compared with a fixed threshold, the crossing of the threshold signifying that the signal is considered to be a signal reflected by a wind turbine.

In a variant of this particular mode of implementation, the spurious-signal model s(t) constructed is a signal whose amplitude at the instants where the signal S_{b}(t) exhibits amplitude peaks is equal to the amplitude of S_{b}(t) and whose amplitude is zero the remainder of the time.

In another variant, the spurious-signal model s(t) constructed is a signal whose amplitude, in the case where the signal is considered to be a signal reflected by a wind turbine, is equal to the maximum amplitude of S_{b}(t).

In a particular mode of implementation of the invention, the first module carries out the construction of a spurious-signal model s(t) on the basis of real-time external information transmitted to the radar, this information providing indications relating to the operating state of the wind turbine whose signal has been detected.

According to the invention, the first module for recognizing the signal reflected by a wind turbine can furthermore comprise a sub-module for filtering the signals corresponding to fixed echoes.

The method according to the invention can furthermore comprise a complementary module for carrying out the estimation of the ambient level A(t) in each zone for which the signal received S_{b}(t) is recognized as corresponding to the signal reflected by a wind turbine, the estimated level being transmitted to the processing situated downstream of the method.

The method according to the invention presents the advantage of implementing a procedure for coherent deletion of a spurious signal originating from a wind turbine, while maintaining optimal conditions of detection of the useful signals.

Moreover, the method according to the invention advantageously makes it possible, for certain radar applications such as, for example, civil air traffic control, to take advantage of external information such as, for example, the position of the wind turbines.

The characteristics and advantages of the invention will be better appreciated by virtue of the description which follows, which description sets forth the invention through a particular embodiment taken as nonlimiting example and which is supported by the appended figures, which figures represent:

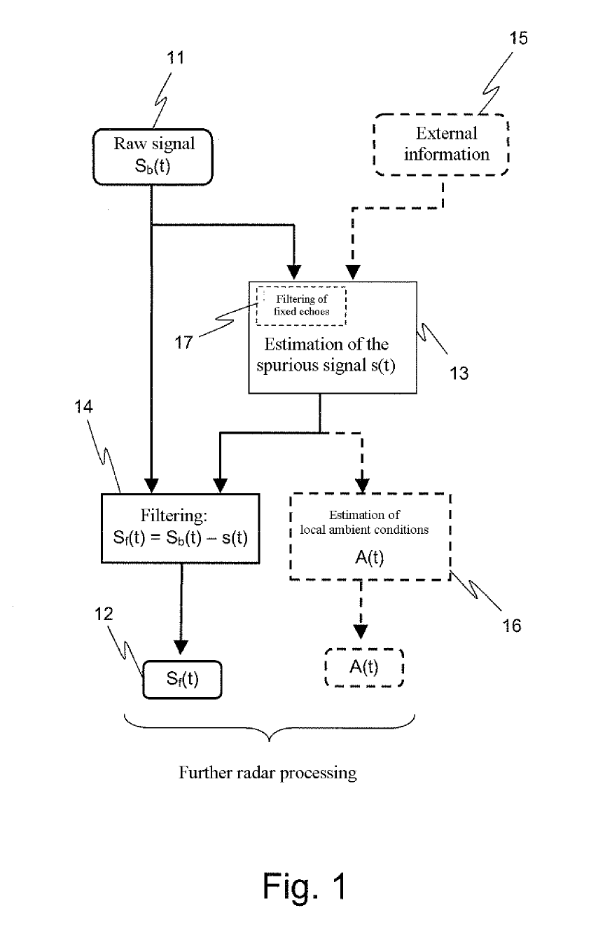

FIG. 1, a basic diagram exhibiting the processing modules constituting the method according to the invention,

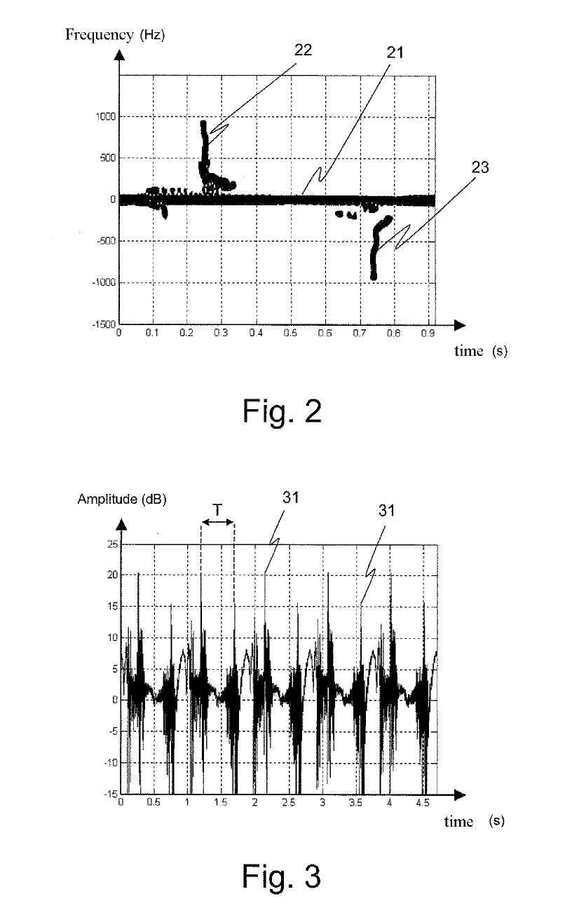

FIG. 2, a spectrogram exhibiting an exemplary signal reflected by a wind turbine;

FIG. 3, a timechart showing the evolution in the course of time of the amplitude of the raw signal received by the radar when this signal corresponding to the exemplary signal reflected by a wind turbine whose spectrogram is exhibited in FIG. 2;

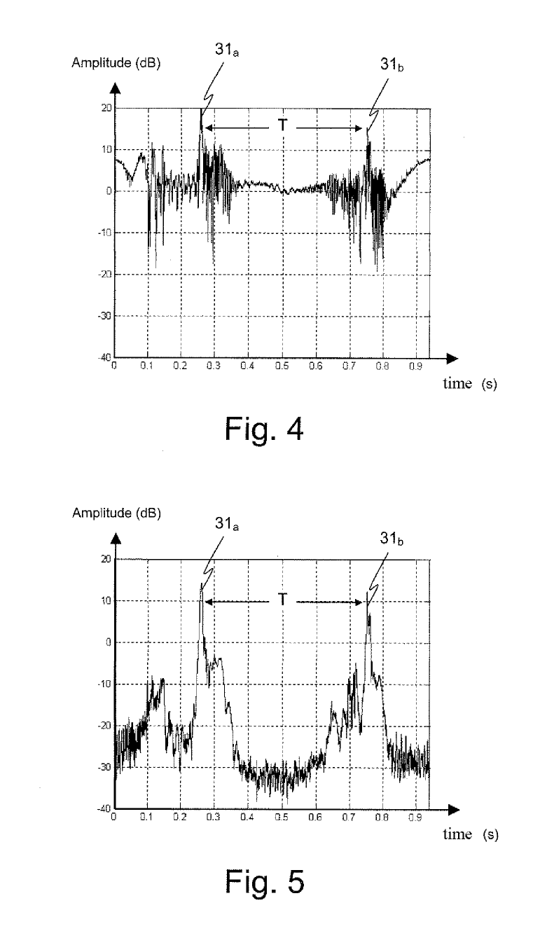

FIGS. 4 and 5, timecharts highlighting the advantage afforded by the implementation of a module for filtering fixed echoes by the method according to the invention.

The proposed solution consists in identifying and subsequently in deleting, in a coherent manner, the spurious signals caused by the reflections of the radar signal on the blades of wind turbines.

FIG. 1, which presents a basic flowchart of the method according to the invention, is considered.

The function of the method according to the invention is to determine whether or not the radar signal S_{b}(t) received at an instant t corresponds to the signal reflected by a wind turbine. According to the invention the signal is analyzed over a given duration corresponding to the illumination time for the direction considered by the radar signal. It mainly comprises two processing modules which are applied to the raw signal 11, S_{b}(t), received by the radar, which modules cooperate with a view to obtaining the desired result, namely to produce a filtered signal 12 ridded of the echoes originating from wind turbines and to transmit the filtered signal to the remainder of the coherent processing chain. The first processing module 13 is responsible mainly for allowing the establishment of a temporal signal model that is best able to represent the signal actually reflected by a wind turbine. The second processing module 14 is for its part responsible for the filtering itself.

The first modeling module 13 relies on the knowledge of the characteristics of the signal reflected by a wind turbine and an identification of certain of these characteristics in the signal received at a given instant.

In a simple form of the method according to the invention, which form does not require the transmission of any particular information to the radar, the knowledge of the characteristics of the signal reflected by a wind turbine is mainly a priori knowledge. According to the invention, the module 13 undertakes the analysis of certain characteristics of the signal S_{b}(t) received so as to determine whether or not this signal corresponds to a signal reflected by a wind turbine, stated otherwise to recognize a wind turbine echo.

The processing relies for this purpose on the fact that the spectral signature of this signal is not stationary, as illustrated by the spectrogram of FIG. 2. Indeed, in view notably of the asynchronism existing between the sequencing of the illuminations carried out by the radar and the speed of rotation of the blades of a wind turbine, the signal reflected by a wind turbine exhibits a Doppler spectrum which varies in a particular manner in the course of time.

The spectrogram of FIG. 2 presents an exemplary signal reflected by a wind turbine. This spectrogram is plotted for a duration of observation corresponding to a rotation of ⅓ of a revolution of the rotor of a wind turbine conventionally comprising 3 blades. It represents a complete period of the signal such as it is received by the radar. This periodic spectrogram makes it possible to distinguish essentially:—a permanent signal 21 at zero frequency (or having very low frequency components) which corresponds essentially to the signals reflected by the fixed or moderately moving parts of the wind turbine, which signal constitutes the “continuous” component of the global signal;—two wideband signals 22 and 23 of very short durations, corresponding to the signal reflected by the wind turbine at the instants at which the blades are perpendicular to the axis of aim of the radar and therefore exhibit strong reflectivity. One of these components corresponds to an advancing blade and the other to a retreating blade.

This particular characteristic of spectral non-stationarity is manifested in the temporal domain by a significant fluctuation of the amplitude of the signal reflected by a wind turbine for the duration of illumination. In practice, as illustrated by FIG. 3, the signal reflected by a wind turbine takes the form of a string of amplitude peaks 31 of brief duration repeated in a periodic manner with a large period 32 relative to the duration of the peaks 31.

The amplitude of this signal is mainly dependent on the physical characteristics of the wind turbine, while the duration of the amplitude peaks 31 is notably dependent on the dimensions of the blades, their speed of rotation ω, and also the wavelength λ of the wave emitted by the radar. The repetition period T of the amplitude peaks is for its part dependent on the speed of rotation ω of the blades of the wind turbine.

The method according to the invention utilizes these temporal characteristics to perform the identification of a wind turbine echo on the basis of the temporal representation of the signal received. In practice, the modeling module 23 analyzes the signal S_{b}(t) received over a defined duration, the illumination time for example, and measures the amplitude variations of the signal over this duration.

In a first mode of implementation, the modeling is carried out by determining the mean value of the amplitude of the signal S_{b}(t) and the maximum deviation in amplitude, D, with respect to this value. This deviation D is then compared with a threshold. Accordingly, if the deviation is greater than this threshold the signal S_{b}(t) is considered to correspond to the signal reflected by a wind turbine. The model signal s(t) is then a signal whose amplitude is zero when the signal S_{b}(t) exhibits an amplitude close to its mean value and whose amplitude is equal to the deviation D between the maximum amplitude of S_{b}(t) and its mean value when this deviation is greater than the threshold considered.

In an alternative mode of implementation the deviation detected is not only compared with a threshold, but the duration of the amplitude variation is taken into account to determine, a priori, on the basis of the waveform of the radar (wavelength) and of the knowledge of the typical properties of wind turbines (span of length of the blades, span of rotation period of the rotor, number of blades) whether a signal exhibiting such an amplitude variation corresponding probably to the signal reflected by a wind turbine. Thus, by fixing for example a minimum duration, the signals exhibiting amplitude variations deemed a priori to be too brief to correspond to the signal reflected by a wind turbine, are excluded from the identification. Accordingly, the signal S_{b}(t) having satisfied the two conditions regarding amplitude and duration, is considered to correspond to the signal reflected by a wind turbine.

In these simple forms of the method according to the invention, the model signal s(t) is, in all cases, determined by analyzing the signal received, as a function of the wind turbine's characteristics defined a priori. The signal s(t) generated is then for example a signal whose amplitude is zero when the signal S_{b}(t) exhibits an amplitude close to its mean value and whose amplitude is equal to the deviation D between the maximum amplitude of S_{b}(t) and its mean value when this deviation is greater than the threshold considered. Alternatively, s(t) can for example consist of a signal whose amplitude is equal to the maximum amplitude of S_{b}(t) for the whole of the duration of analysis, the duration of illumination for example, when the signal S_{b}(t) is recognized as a signal reflected by a wind turbine or of zero amplitude for the whole of the duration of analysis when the signal S_{b}(t) is not recognized as a signal reflected by a wind turbine.

It should be noted that, to facilitate the amplitude measurements carried out and in particular to prevent fixed echoes of high level which are present in the analyzed zone from greatly hindering the amplitude measurements, the module 13 comprises, in a preferred mode of implementation, a sub-module 17 for eliminating fixed echoes. The elimination of fixed echoes is carried out here by any known means, by spectral rejection of the signals with zero frequency for example. The use of this sub-module 17 makes it possible to identify the presence of the spurious signal more effectively, even when its amplitude is small with respect to that of the fixed echoes which accompany it (such as for example the echoes caused by the reflection on the mast or the nacelle of the wind turbine). The benefit of this sub-module is illustrated by FIGS. 4 and 5.

FIG. 4 presents the timechart of an exemplary signal S_{b}(t) reflected by a wind turbine. The signal presented here is the same as the signal whose spectrogram is presented in FIG. 2. It represents a complete period of the signal such as it is received by the radar. As may be noted the mean level of the signal received is relatively high since it consists of the combination of the fixed echoes (mast, nacelle, fixed parts of the rotor) forming a background signal and moving echoes (moving parts of the rotor) reflected by the wind turbine, represented by the amplitude peaks 31ₐ and 31_{b}. Accordingly the deviation between the level of the amplitude peaks 31 and the mean level of the signal is limited. Hence it is sometimes difficult to identify a wind turbine echo by simply measuring this deviation.

FIG. 5 presents for its part the timechart of the same exemplary signal after application of a filtering operation aimed at eliminating the components of this signal corresponding to the fixed echoes. The representation scales used here are the same as those of FIG. 4. As may be noted in FIG. 5, the variation of the amplitude of the signal is much easier to distinguish, after application of a filter which rejects the fixed echoes, than in FIG. 4, in particular, at the level of the peaks 31 which correspond to the instants at which the reflection on the blades is significant. It should be noted in this regard that one of the peaks, 31ₐ for example, corresponds to the blade which on account of the rotation is approaching the radar, and that the other peaks, 31_{b} for example, corresponds to the blade which is moving away from the radar.

The model signal s(t) which represents the spurious signal is transmitted to the filtering module 14, the main function of which is to eliminate from the signal S_{b}(t) received any spurious component corresponding to the signal reflected by a wind turbine. Accordingly, the filtering operation consists, in a simple manner, in subtracting the signal model s(t) defined by the module 13 from the raw radar signal S_{b}(t). A filtered signal is thus obtained, ridded totally or partially of its spurious component depending on whether the amplitude and duration characteristics of the signal s(t) correspond more or less closely to those of the signal actually reflected by a wind turbine.

This first simple form of the method according to the invention presents the advantage of being able to be implemented by any existing radar equipment, in the sense that it does not require the setting up of any complementary structure. A radar operating alone can integrate the method according to the invention into its coherent processing, simply by storing a more or less sophisticated wind turbine behavior model on the basis of which a reflected signal model may be constructed a priori in real time. This signal model s(t) is then used by the filtering module to eliminate from the signal received the spurious echoes constituted by the echoes of wind turbines. However, having regard to the fact that such a model does not take into account the actual state at the instant considered of the wind turbine illuminated by the radar, the signal model corresponds only approximately to the signal actually reflected by the wind turbine. Accordingly the filtering carried out only eliminates the spurious signal in an incomplete manner.

This is why in a more sophisticated form, the modeling module 13 of the method according to the invention comprises a data exchange module responsible notably for receiving in real time, that is to say with a renewal rate tied to the typical time constant of wind turbines (typically a few seconds), the data relating to the operation of the wind turbines present in the space monitored by the radar. This information is mainly the orientation of the rotor as well as the speed of rotation and the orientation of the blades. It may furthermore be a synchronization date, the date at which the rotor passes through a known reference angular position for example. The latter information is provided at each rotor revolution, that is to say typically every 2 to 3s for a conventional wind turbine.

This information associated with the data corresponding to the static characteristics such as the dimension of the blades allows the modeling module to construct in real time a model signal s(t) that is truly close to the signal actually reflected by the wind turbine considered. Accordingly the effectiveness of the filtering module 14 is generally greatly increased. Nonetheless, the input of these external data is more or less significant depending on the type of radar. For example, for fixed-antenna monostatic or multistatic radars, which have the ability to permanently receive signals reflected by the targets throughout all or part of their coverage, it is not indispensable to have the dynamic data, insofar as the radar is itself capable of formulating a temporal estimation of the spurious signal.

Whatever the form of implementation of the method according to the invention, simple form without external input of information relating to the wind turbines or else more elaborate form with exchanges of information, the method can comprise, in addition to its main modules 13 and 14, a complementary module 16 responsible for carrying out a local estimation of ambient conditions A(t). The object of this local estimation is to integrate into the estimation of ambient conditions normally carried out in a given sector, the contribution of the presence of a wind turbine to this ambient level, the echoes of wind turbines thus being considered to be particular clutter whose characteristics are transmitted to the coherent processing chain, situated downstream of the processing carried out by the method according to the invention. This estimation of a level of local ambient conditions can in particular be utilized advantageously by the coherent processing so as to avoid falsifying the estimations of ambient conditions carried out in zones neighboring the zones containing wind turbines.

1. A method for filtering the radar echoes produced by wind turbines, said wind turbines being positioned in the space covered by a radar comprising means for carrying out the automatic tracking of moving echoes, the method being applied to the radar signal received S_{b}(t) by analyzing this signal over a given duration, comprising:
a first module for recognizing the signal reflected by a wind turbine and for constructing a spurious-signal model s(t), this model constituting an estimation, for the duration considered, of the signal reflected by a wind turbine;
a second module for filtering the radar signal received S_{b}(t), by subtracting the signal s(t) from the signal S_{b}(t);
the filtered signal S_{f}(t) being transmitted to the signal processing functions situated downstream of the method.

2. The method as claimed in claim 1, wherein the recognition of the signal reflected by a wind turbine is carried out by analyzing the variation in the course of time, for the duration of observation, of the amplitude of the raw signal S_{b}(t) received.

3. The method as claimed in claim 2, wherein the recognition of a signal reflected by a wind turbine is carried out by searching for amplitude peaks and by determining the duration of these peaks and the amplitude deviation existing between these peaks and the mean value of the signal S_{b}(t) over the duration of observation, this deviation being compared with a fixed threshold, the crossing of the threshold signifying that the signal is considered to be a signal reflected by a wind turbine.

4. The method as claimed in claim 3, wherein the spurious-signal model s(t) constructed is a signal whose amplitude at the instants where the signal S_{b}(t) exhibits amplitude peaks is equal to the amplitude of S_{b}(t) and whose amplitude is zero the remainder of the time.

5. The method as claimed in claim 3, wherein the spurious-signal model s(t) constructed is a signal whose amplitude, in the case where the signal is considered to be a signal reflected by a wind turbine, is equal to the maximum amplitude of S_{b}(t).

6. The method as claimed in claim 1, wherein the first module carries out the construction of a spurious-signal model s(t) on the basis of real-time external information transmitted to the radar, this information providing indications relating to the operating state of the wind turbine whose signal has been detected.

7. The method as claimed in claim 1, wherein the first module for recognizing the signal reflected by a wind turbine further comprises a sub-module for filtering the signals corresponding to fixed echoes.

8. The method as claimed in claim 1, further comprising a complementary module for carrying out the estimation of the ambient level A(t) in each zone for which the signal received S_{b}(t) is recognized as corresponding to the signal reflected by a wind turbine, the estimated level being transmitted to the processing situated downstream of the method.
